(19) United States
(12) Patent Application Publication
(10) Pub. No.: US 2014/0019929 A1
(43) Pub. Date: Jan. 16, 2014

(54) Partial Instruction-by-instruction checking on acceleration platforms

(71) Applicant: International Business Machines Corporation, Armonk, NY (US)

(72) Inventors: Gal Raviv, Kamon (IL); Anatoly Koyfman, Kiriat Yam (IL); Ronny Morad, Kiriat Ata (IL); Avi Ziv, Haifa (IL)

(73) Assignee: International Business Machines Corporation, Armonk, NY (US)

(21) Appl. No.: 14/016,141

(22) Filed: Sep. 2, 2013

Related U.S. Application Data
(63) Continuation-in-part of application No. 13/471,536, filed on May 15, 2012, now Pat. No. 8,601,418.

(51) Int. Cl. G06F 17/50

(52) U.S. Cl. CPC G06F 17/5081
USPC 716/112

(57) ABSTRACT

A method, apparatus, and product for partial instruction-by-instruction checking on acceleration platforms. The method comprising: obtaining a trace from an hardware accelerator, wherein the trace is generated by the hardware accelerator during simulation of an execution of a test case on a circuit design; identifying a synchronization point in the trace; simulating execution of the test case by a reference model until reaching the synchronization point; and performing instruction-by-instruction checking in order to identify an error in the circuit design based on the simulated execution by the hardware accelerator, wherein the instruction-by-instruction checking is performed with respect to a portion of the trace that relates to operation after executing the synchronization point, wherein the instruction-by-instruction checking utilizes the reference model to determine an expected outcome of each event recorded in the portion of the trace.

### CROSS-REFERENCE TO RELATED APPLICATIONS

This application is a continuation-in-part application and claims the benefit of U.S. non-provisional application Ser. No. 13/471,536 filed May 15, 2012, which is hereby incorporated by reference in its entirety.

### TECHNICAL FIELD

The present disclosure relates circuit design verification in general, and to circuit design verification using acceleration platforms, in particular.

### BACKGROUND

Computerized devices control almost every aspect of our life—from writing documents to controlling traffic lights. However, computerized devices are bug-prone, and thus require a testing phase in which the bugs should be discovered. The testing phase is considered one of the most difficult tasks in designing a computerized device. The cost of not discovering a bug may be enormous, as the consequences of the bug may be disastrous. For example, a bug may cause the injury of a person relying on the designated behavior of the computerized device. Additionally, a bug in hardware or firmware may be expensive to fix, as patching it requires call-back of the computerized device. Hence, many developers of computerized devices invest a substantial portion of the development cycle to discover erroneous behaviors of the computerized device.

During the development cycle of a circuit, the functionality of the circuit may be analyzed using functional verification. Functional verification may be performed using a simulator, such as HDL simulator, which provides a software simulation of the behavior of the circuit. Additionally or alternatively, an acceleration platform, also referred to as an “accelerator” or a “hardware accelerator”, may be utilized to perform functional verification. The accelerator is a hardware-based simulator of the circuit design, such as using Application-Specific Integrated Circuit (ASIC), Field Programmable Gate Array (FPGA), or the like.

As accelerator is implemented in hardware it is much faster than a simulator. On the downside, there is a reduced visibility to the value of each signal in the circuit design during the simulated execution by the accelerator with respect to a simulator.

Instruction-by-Instruction (IBI) checking is a method of checking that a circuit design behaves correctly at the architectural level during simulation. An IBI checker operates during simulation and typically checks three things: (1) Instructions are completed in program order; (2) Register that are expected to be updated, are indeed updated with their expected values; and (3) Registers that are not expected to be updated, are indeed not updated.

### BRIEF SUMMARY OF THE INVENTION

One exemplary embodiment of the disclosed subject matter is a computer-implemented method performed by a computerized device, comprising: obtaining a trace from an hardware accelerator, wherein the trace is generated by the hardware accelerator during simulation of an execution of a test case on a circuit design, wherein the trace includes information regarding instructions which are completed by the circuit design and regarding register value modifications; identifying a synchronization point in the trace; simulating, by the computerized device, execution of the test case by a reference model until reaching the synchronization point; and performing, by the computerized device, instruction-by-instruction checking in order to identify an error in the circuit design based on the simulated execution by the hardware accelerator, wherein the instruction-by-instruction checking is performed with respect to a portion of the trace that relates to operation after executing the synchronization point, wherein the instruction-by-instruction checking utilizes the reference model to determine an expected outcome of each event recorded in the portion of the trace.

Another exemplary embodiment of the disclosed subject matter is a computerized apparatus having a processor, the processor being adapted to perform the steps of: obtaining a trace from an hardware accelerator, wherein the trace is generated by the hardware accelerator during simulation of an execution of a test case on a circuit design, wherein the trace includes information regarding instructions which are completed by the circuit design and regarding register value modifications; identifying a synchronization point in the trace; simulating execution of the test case by a reference model until reaching the synchronization point; and performing, by the computerized device, instruction-by-instruction checking in order to identify an error in the circuit design based on the simulated execution by the hardware accelerator, wherein the instruction-by-instruction checking is performed with respect to a portion of the trace that relates to operation after executing the synchronization point, wherein the instruction-by-instruction checking utilizes the reference model to determine an expected outcome of each event recorded in the portion of the trace.

Yet another exemplary embodiment of the disclosed subject matter is a computer program product comprising a non-transitory computer readable medium retaining program instructions, which instructions when read by a processor, case the processor to performs the steps of: obtaining a trace from an hardware accelerator, wherein the trace is generated by the hardware accelerator during simulation of an execution of a test case on a circuit design, wherein the trace includes information regarding instructions which are completed by the circuit design and regarding register value modifications; identifying a synchronization point in the trace; simulating execution of the test case by a reference model until reaching the synchronization point; and performing, by the computerized device, instruction-by-instruction checking in order to identify an error in the circuit design based on the simulated execution by the hardware accelerator, wherein the instruction-by-instruction checking is performed with respect to a portion of the trace that relates to operation after executing the synchronization point, wherein the instruction-by-instruction checking utilizes the reference model to determine an expected outcome of each event recorded in the portion of the trace.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a computerized environment in which the disclosed subject matter is used, in accordance with some exemplary embodiments of the subject matter;

FIG. 2 shows a block diagram of an apparatus, in accordance with some exemplary embodiments of the disclosed subject matter;

FIG. 3 shows a flowchart diagram of a method, in accordance with some exemplary embodiments of the disclosed subject matter;

FIG. 4 shows a flowchart diagram of a method, in accordance with some exemplary embodiments of the disclosed subject matter; and

FIG. 5 shows an illustration of a test case, in accordance with some exemplary embodiments of the disclosed subject matter.

### DETAILED DESCRIPTION

The disclosed subject matter is described below with reference to flowchart illustrations and/or block diagrams of methods, apparatus (systems) and computer program products according to embodiments of the subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

A “design”, a “circuit” or a “circuit design”, as used herein, is a functional definition of an electronic circuit. A design may be provided using any Hardware Descriptive Language (HDL) including but not limited to VHDL, Verilog, SystemC, EDL, RTL, PSL or the like. In some exemplary embodiments, the design may correspond to an Integrated Circuit (IC) or a different hardware product.

One technical problem dealt with by the disclosed subject matter is to provide an Instruction-By-Instruction (IBI) checking capability during functional verification performed by a hardware accelerator.

Having an IBI checking capability on an acceleration platform may be desirable for several reasons. As one example, IBI checking may facilitate debugging in cases where long computations complete with wrong results. In such a case IBI checking can point to the exact location of the instruction that causes the problem.

In some cases, IBI checking may slow down the simulation or may result in creation of relatively big trace files. As a result of these factors, it may not be desirable to use IBI checking extensively. In addition, performing IBI checking on long traces may not be feasible. As an example, a trace provided by an accelerator may include billions of cycles, while a reference model and a simulator may only be capable of efficiently handling traces of a significant smaller degree, such as for example including hundred thousands of cycles or a few millions of cycles. Such limitation may be referred to as an efficiency limit of the reference model or simulator.

One technical solution is to perform partial IBI checking based on a trace provided by an accelerator executing a test case. IBI checking may be performed, for example, based on a trace recorded by an accelerator during which a failure occurred for debugging purposes.

A reference model may be utilized for IBI checking only the portion of the trace generated by an accelerator. The reference model may execute the test case and only upon reaching the portion commence performing IBI checking and comparing its results to the results in the trace.

In some exemplary embodiments, the portion of the trace may commence in a synchronization point, also referred to as a sync point. The sync point may be an instruction after which the state of the circuit design can be concluded. The sync point may be, for example, a first instruction at the beginning of a test immediately after the state of the machine is initialized for the test. In some cases, the instruction may be a semaphore instruction or additional synchronization instruction. Additionally or alternatively, in a multi-threaded environment, the sync point may be at a barrier function during which all threads are initialized. The barrier function may be completed only after all threads are initialized though the order of execution may not be a prior known.

In some exemplary embodiments, the test case may include a plurality of tests that are performed by the accelerator. One example may be of an exerciser which repeatedly generates a test and executes the generated test. After the test is generated, the state of the machine may be initialized in order to perform the test. The sync point may be located after such initialization is concluded. Another example may be a test case which is hard-coded to perform a plurality of separable tests, before each of which an initialization phase is performed.

In some exemplary embodiments, the reference model may execute the test case without performing IBI checking until the sync point is reached, after which IBI checking may be performed with respect to the portion of the trace.

The disclosed subject matter provides for a technical solution that enables bringing the reference model to the same state as the recorded state of the circuit design without performing IBI checking. Such execution may be faster and potentially require fewer resources than an execution which performs IBI checking, hence may be feasible for larger traces.

The disclosed subject matter may provide for an identification of the portion of the trace for which IBI checking is performed. The portion may be based on the first sync point in the trace, the sync point that is located closest to the failure point, the sync point that is located immediately after a checkpoint associated with the failure, or the like.

It will be noted that a checkpoint may be provided by the accelerator when a failure is detected. The checkpoint, as is known in the art, may be a full snapshot of the circuit design at a specific cycle. The checkpoint may be used to replay the same execution by the design. In some exemplary embodiments, accelerators, simulators or a similar tool may be configured to create a checkpoint at a predetermined timing, periodically, or the like. In some exemplary embodiments, the tool may be initially used to execute the design without generating a checkpoint. In response to receiving an indication that the execution induced an error, the tool may be used again and be configured to generate the checkpoint prior to the identification of the error, so as to be created prior to the error root cause. In some exemplary embodiments, the checkpoint is prior to a sync point that is prior to the error root cause.

In some exemplary embodiments, the accelerator may execute the test case until a failure is detected. In response to such detection, the accelerator may be reloaded with the checkpoint to re-execute the test case from the checkpoint in order to produce a trace. The re-execution may be performed with respect to a circuit design that is augmented with a tracer module in order to produce the trace.

In some exemplary embodiments, as the checkpoint is a state of the circuit design and does not represent an architecture state of the design it may not be used in order to set the state of the reference model. Instead, the state of the reference model is set by executing the test case and reaching a sync point that is included in the trace.

In some exemplary embodiments, a hardware implementation of a tracer module that is configured to collect and record information relating to the operation of the circuit design may be introduced to the circuit design. In some exemplary embodiments, the tracer module collects and records a subset of the information that software simulation-based IBI checkers use, so as to reduce the overhead of performing IBI checking. In some exemplary embodiments, two types of information are collected and recorded: (1) instructions which are completed by the circuit design, and (2) register value modifications during the execution of the test case. In some exemplary embodiments, the collected data may be address and affiliation (e.g., core and thread id) of each completed instruction and the value, identity and affiliation of each register modified during the execution of the test case. In some exemplary embodiments, the tracer module may be configured to record the information in the order the events occur.

The recorded information, also referred to as a trace, may be off-loaded from the hardware accelerator to an alternative machine, such as a server, which may perform software implemented IBI checking by comparing the events and the order in which they occurred with the expected events. In some exemplary embodiments, a software-based reference model may be utilized to determine expected events.

In some exemplary embodiments, in response to each recorded completed instruction, it may be verified that the next instruction to be executed in the reference model is the completed instruction, and the instruction execution may be simulated by the reference model. All register modifications in the reference model may be stored in a register storage. Additionally or alternatively, in response to each recorded register modification, the register storage may be examined to verify that a corresponding register modification exists. The corresponding register modification may be removed from the register storage. The disclosed subject matter may determine using the reference model that the recorded register modification is justified.

It will be noted that in some exemplary embodiments the relation between which instruction is completed and which register modifications were performed is not recorded. Such information may be omitted and not recorded in order to reduce the overhead of the disclosed subject matter on the hardware accelerator.

In some exemplary embodiments, IBI checking may be performed with respect to a portion of the trace. The trace may correspond to a portion of the execution of the test case by the accelerator.

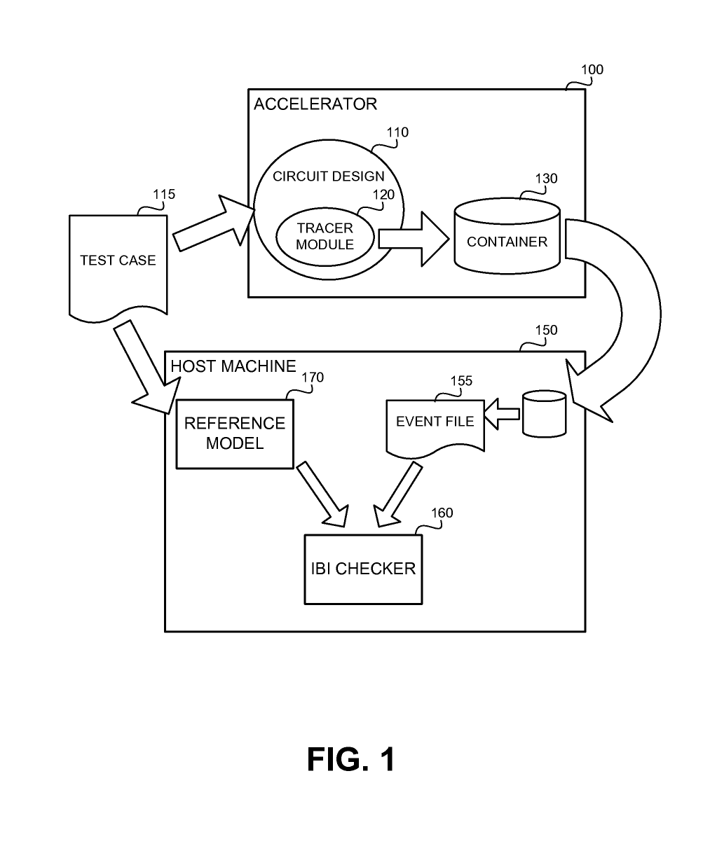

Referring now to FIG. 1 showing a computerized environment in which the disclosed subject matter is used, in accordance with some exemplary embodiments of the subject matter.

An Accelerator 100 is a hardware accelerator having the capability of simulation, in hardware, an operation of a circuit design. Design 110 may be a circuit design of a target processor, chip, IC, or other circuit. Design 110 may be provided in a computer-readable form, such as using a hardware description language. In some exemplary embodiments, Design 110 may be provided in a VHDL form. Accelerator 100 may be operative to simulate operation of Design 110.

Design 110 may be enhanced by a Tracer Module 120. Tracer Module 120 may be configured to track instruction completion by Design 110, with respect to a Test case 115. Additionally or alternatively, Tracer Module 120 may be configured to track register updates by Design 110 in response to performing instructions of Test case 115. Tracer Module 120 may be provided in a computer-readable form, such as using a hardware description language. Tracer Module 120 may be provided in the same hardware description language used to define Design 110. In some exemplary embodiments, Design 110 may be enhanced by Tracer Module 120 by inlining or otherwise including Tracer Module 120 in Design 110.

In some exemplary embodiments, Tracer Module 120 may be configured to store tracked data in a Container 130 or using other data storage.

In some exemplary embodiments, Tracer Module 120 may comprise dedicated logic that will pack and compress the reported information in order to minimize the degradation of acceleration performance caused by the information off-loading.

In some exemplary embodiments, Accelerator 100 may be configured to simulate execution of Design 110 without Tracer Module 120 until a failure is detected. In response to failure detection a checkpoint may be generated providing a state of Design 110 before the failure. Accelerator 100 may re-execute Test case 115 by Design 110 being augmented by Tracer Module 120. The re-execution may be performed from the checkpoint by setting the state of Design 110 using the checkpoint.

An off-loading process may be performed to off-load the recorded information from Accelerator 100 to a Host Machine 150 or other computerized apparatus. In some exemplary embodiments, off-loading may be performed periodically. In some exemplary embodiments, off-loading may be performed in response to a buffer of Container 130 reaching a threshold. In some exemplary embodiments, when off-loading data from Accelerator 100, simulation of Design 110 may be paused.

Based on the recorded information that is off-loaded to Host Machine 150, Host Machine 150 may generate an Event File 155 or a similar computer-retainable and computer-readable form comprising identified events. The event file may comprise events that were recorded. In some exemplary embodiments, there may be three types of events: (1) instruction completed, (2) register written and (3) test ended. The first two events may be extracted from the information off-loaded from Accelerator 100. The “test ended” event may be added automatically at the end of the event file. Alternatively or additionally, the “test ended” event may be added based on a recorded report that Test case 115 was completed by the simulated operation of Design 110 by Accelerator 100.

An IBI Checker 160 may be configured to perform IBI checking of the operation of the Design 110 based on the off-loaded information. In some exemplary embodiments, IBI Checker 160 may perform IBI checking based on the generated event file. IBI Checker 160 may be a software-implemented checker that is executed by the hardware of Host Machine 150. IBI Checker 160 may be operatively coupled to a Reference Model 170 and utilize it to identify and report errors. IBI Checker 160 may run Reference Model 170 in parallel to the simulation and compare results obtained in the simulation environment with the results predicted by Reference Model 170. In some exemplary embodiments, expected results may be compressed using the same compression algorithm utilized to compress the recorded information, and the compressed actual results may be compared with the compressed expected results. A discrepancy between the results may indicate a bug.

Reference Model 170, also referred to as a golden model, may be operative to provide expected results of the Design 110 in response to Test case 115. In some cases, Reference Model 170 may be available. For example, Reference Mode 170 may be available from the architecture owner (e.g., when developing a design that complies with public architecture, such as ARM or Power). Additionally or alternatively, Reference Model 170 may be developed by the design tool team. Additionally or alternatively, a previous version of the design may be utilized as a Reference Model 170. Reference Model 170 may be a software implantation of Design 110, an alternative implementation of Design 110, or the like.

In some exemplary embodiments, IBI Checker 160 may be provided with a set of expected results, such as manually defined by a user preparing Test case 115 or automatically determined using a Reference Model 170. IBI Checker 160 may therefore not require to run Reference Model 170 in parallel to the simulation.

IBI Checker 160 may be configured to provide different checks. IBI Checker 160 may check that instructions completed in order. IBI Checker 160 may check that all modified registers are as expected. IBI Checker 160 may check that, when a test ends, all reported register modifications during the tests are accounted for by the expected results.

IBI Checker 160 may be configured to cause Reference Model 170 to load Test case 115 (i.e., the same program that is run on Accelerator 100). For each event in the event file IBI Checker 160 may perform appropriate actions. In some exemplary embodiments, IBI Checker 160 may commence checking only for a portion of the event file, such as checking only the portion of the trace beginning after a sync point. Reference Model 170 may be executed until the sync point without performing IBI checking and the IBI checking may commence after the sync point and with respect to the portion of Event File 155 that corresponds to the operation of Accelerator 100 after reaching the sync point

In response to an event indicating that an instruction was completed, IBI Checker 160 may check that address of the completed instruction is the address of the next instruction to be executed in Reference Model 170, therefore checking order of execution of the instructions. In addition, IBI Checker 160 may cause Reference Model 170 to simulate execution of the instruction and identify expected register modifications in response thereto. The register modifications may be stored, e.g., in a register storage or other data structure.

In response to an event indicating a register modification by Design 110, the register storage or other data storage may be inspected to determine whether the recorded register modification was expected by Reference Model 170. In case an appropriate register value modification is found, it can be determined that there is a justification to the register value modification by an instruction that was previously completed in the Reference Model 170. In case no such expected register value modification is found, an error may be reported as the register modification was not expected.

It will be noted that in some cases, registers may take a while to update and as the disclosed subject matter may store register value modification events as they occur (and in connection with the completed instruction), several instructions may be completed prior to seeing the effects of a previously completed instruction on the registers. By storing all expected register value modification in a single data structure, the data structure may be used to ensure that each register value modification is justified in view of an instruction which was already completed.

In some exemplary embodiments, in case that an appropriate register modification is identified in the data structure, that modification may be removed from the data structure as it used to justify the current examined event and should not be used to justify future event. By removing such register value modifications from the data structure it may be ensured that each such expected register value modification is used to justify exactly one register value modification event.

In response to a test end event, the data structure may be examined to check that it is empty. If the data structure is not empty, an error may be reported as an expected register value modification has not occurred.

In some exemplary embodiment, the data structure may provide in the expected register value modification information the instruction which is expected (e.g., by Reference Model 170) to cause the expected register value modification. Therefore, a report of an error may indicate which instruction did not perform its full effect.

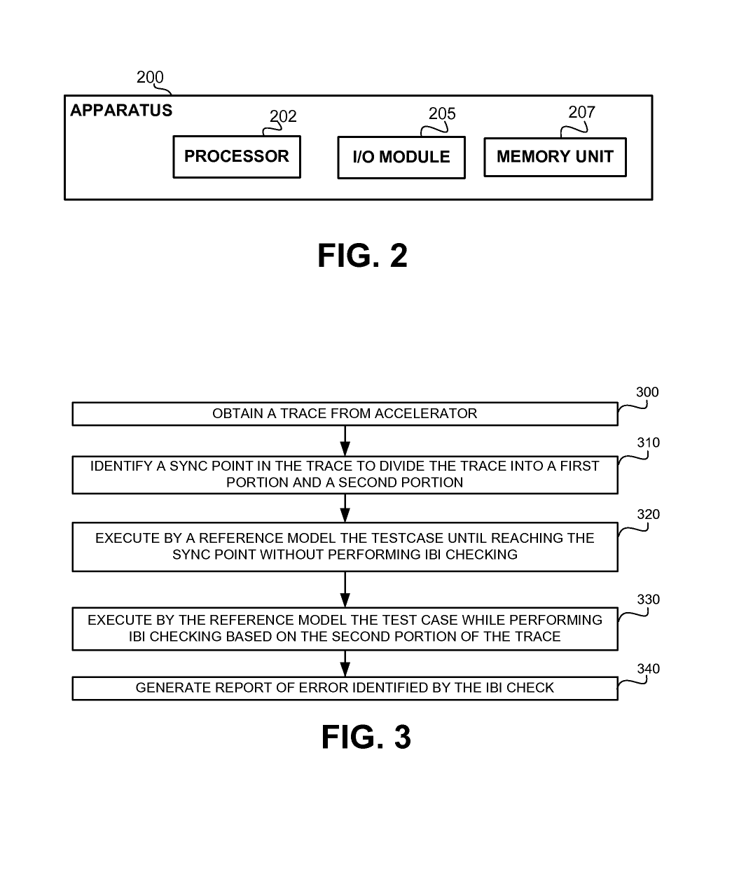

Referring now to FIG. 2 showing an apparatus in accordance with some exemplary embodiments of the disclosed subject matter. An apparatus 200, such as 150 of FIG. 1, may be configured to perform IBI checking based on a simulated execution by an hardware accelerator, in accordance with the disclosed subject matter.

In some exemplary embodiments, Apparatus 200 may comprise a Processor 202. Processor 202 may be a Central Processing Unit (CPU), a microprocessor, an electronic circuit, an Integrated Circuit (IC) or the like. Processor 202 may be utilized to perform computations required by Apparatus 200 or any of it subcomponents. Processor 202 may be configured to execute Reference Model 170, IBI Checker 160, or the like. Processor 202 may be configured to analyze off-loaded information and generate event file.

In some exemplary embodiments of the disclosed subject matter, Apparatus 200 may comprise an Input/Output (I/O) Module 205. I/O Module 205 may be utilized to provide an output to and receive input from a user. I/O Module 205 may be operative to provide an error report to a user, such as a QA staff member, a verification engineer, a circuit designer, or the like.

In some exemplary embodiments, Apparatus 200 may comprise a Memory Unit 207. Memory Unit 207 may be a short-term storage device or long-term storage device. Memory Unit 207 may be a persistent storage or volatile storage. Memory Unit 207 may be a disk drive, a Flash disk, a Random Access Memory (RAM), a memory chip, or the like. In some exemplary embodiments, Memory Unit 207 may retain program code operative to cause Processor 202 to perform acts associated with any of the subcomponents of Apparatus 200. Memory Unit 207 may retain information off-loaded from Accelerator 100. Memory Unit 207 may retain generated event file. Memory Unit 207 may retain register storage or similar data structure.

Referring now to FIG. 3 showing a flowchart diagram of a method in accordance with some exemplary embodiments of the disclosed subject matter.

In Step 300, a trace may be obtained from an accelerator. The trace, such as Event File 155, may include recorded information relating to the execution of a test case by the accelerator.

In Step 310, an execution of a sync point may be identified in the trace. Based on the sync point, the trace may be divided into a first portion and a second portion.

In Step 320, a reference model may be used to simulate execution of the test case until the reaching the sync point. The reference model may be executed without performing IBI checking.

By executing the reference model until reaching the sync point, the state of the reference model may be considered as in line with the state of the recorded execution of the accelerator which is provided in the second portion of the trace.

In Step 330, the reference model may continue to execute the test case after the sycn point while performing IBI checking with respect to the second portion of the trace.

IBI checking may be performed by determining that for each recorded register value modification there is a justification by an instruction which was completed prior to the register value modification. The reference model may be utilized to obtain expected results of completing each instruction. Furthermore, the reference model may ensure that the order of instruction operation is as expected. Furthermore, the reference model may be used to ensure that all expected register modifications have occurred in the simulated execution performed by the accelerator.

In some exemplary embodiments, the IBI checking may utilize register storage or a similar data structure to record expected register value modifications expected by the reference model in response to completing instruction. The data structure may be inspected to determine that each register value modification event in the accelerator is justified by the reference model based on a previously completed instruction.

In Step 340, a report may be generated providing errors identified during the IBI checking. The report may be provided in a human readable form, may be printed, may be displayed using a display, or otherwise provided to a user.

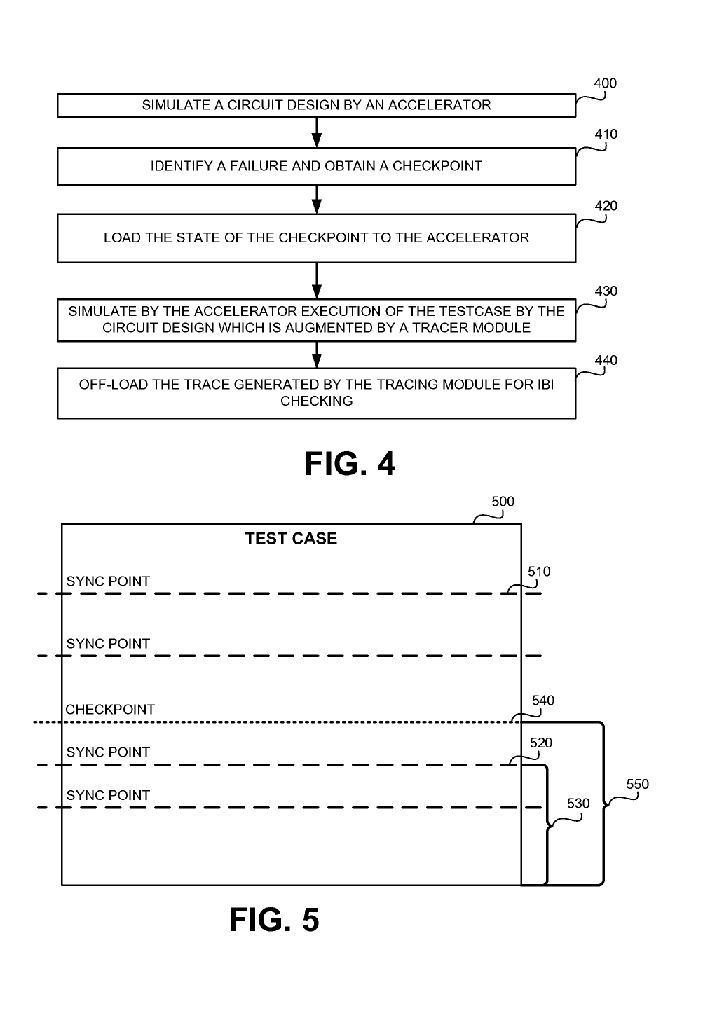

Referring now to FIG. 4 showing a flowchart diagram of a method in accordance with some exemplary embodiments of the disclosed subject matter.

In Step 400, an accelerator may be used to simulate execution of a circuit design. The accelerator may be used to simulate execution of a test case.

In Step 410, during simulation, a failure may be identified and a checkpoint before the failure may be obtained. The error identification can be delayed from its root cause. Hence, the method may be aimed at generating the checkpoint in a cycle that is prior to the section including the error root-cause and the error indication.

In Step 420, the state of the accelerator may be reset to the state stored in the checkpoint.

In Step 430, the accelerator may be used to simulate execution of the test case (from the state reached to in the checkpoint) by the circuit design when augmented by a tracer module. The tracer module may be utilized to trace information relating to the execution of the test case.

In some exemplary embodiments, the circuit design may be augmented by tracer module in Step 400 but may be optionally disabled such as by providing it with a disable signal. During Step 430, the tracer module may be enabled by providing it with an enable signal.

FIG. 5 shows an illustration of a test case, in accordance with some exemplary embodiments of the disclosed subject matter.

Box 500 illustrates an execution of test case having a plurality of instructions for the circuit design. The execution defines a sequence of executed instructions.

Box 500 may include several sync points such as 510, 520. The sync points may be identified, for example, based on a value of an instruction pointer, a program counter, or the like. As can be appreciated the same instruction may appear more than once in Box 500, such as in case of a loop. Different sync points of Box 500 originating from the same instruction may be differentiated based on its sequential occurrence. For example, Sync Point 510 and Sync Point 520 may be associated with the same instruction. Sync Point 510 may be the first time the execution reaches the instruction while Sync Point 520 may be the second time the execution reaches the same instruction.

One sync point, such as 520, preferably prior to a failure (not shown), may be used as a point of synchronization between the reference model and a trace of an accelerator. The reference model may execute the test case until reaching Sync Point 520. After such point, the reference model may be deemed as having the same state as the accelerator had when executing Sync Point 520. After reaching Sync Point 520, the reference model may used for IBI checking of the portion of the trace which commences after the same sync point.

In some exemplary embodiments, IBI checking may be performed with respect to Section 530 and not prior to it.

In some exemplary embodiments, the accelerator may be used without tracing its operation until a failure is detected. In response to such a failure, a checkpoint may be generated. The accelerator may be set with the state of the checkpoint and a tracer module may be utilized to provide a trace of the operation of the circuit design, as simulated by accelerator. In such an embodiment, the trace may relate to Section 550 and may not include information prior to it.

As can be appreciated, the checkpoint may not be located at a sync point and the state of the reference model may not be set using the checkpoint. As such, the first sync point after the checkpoint may be used to synchronize the state of the reference model with the state of the recorded execution by the accelerator.

### Multi Threaded Designs

In some exemplary embodiments, the circuit design may be multi threaded or otherwise introduce parallel or concurrent execution entites. In such an embodiment, a sync point should indicate that the state of every thread is known and in line with the trace. The sync point may therefore be chosen to be at an end of a barrier function. A barrier function may be a function in the test case which is intended to sync between the threads. It may use semaphores and may act as follows for each thread as it enters this function:

(1) Mark yourself as “in barrier”;
(2) While not all threads have entered the barrier function do:
wait and check again;
   (3) Complete the barrier function

The order of the threads leaving the barrier may be unknown, however, at this point the architectural state per each thread can be concluded.

A pseudo-algorithm to implement the disclosed subject matter may be:

(1) Identify the potential sync points in the given test case. barrier functions in the test case can be identified by their first and last instruction program counter and the sync point may be an instruction in the barrier function such as the last instruction of the barrier function. In the absence of barrier functions, artificial sync points can be introduced to the test case.
(2) Find the nearest sync point after the given checkpoint.
(3) Initiate the reference model with the original test initialization state.
(4) Run the reference model in “fast forward” mode (without advancing the event file) until reaching the chosen sync point. Order of execution of the threads may be set based on a round-robin order or based on any other order.
(5) Set all threads state to “pre checking”. In this state the thread events are ignored.
(5.1) Start processing the event file (e.g., the one created by the run from the checkpoint). Ignore all the events (instruction-completion and register-update) for each thread in pre checking state.
(5.2) When a thread reaches the last barrier instruction (which can be identified by its program counter), set the thread state to “checking”.
(5.3) From this point on, perform IBI checking for this thread: in response to an event associated with the thread, perform IBI checking by simulating the same event on the reference model and comparing the result.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of program code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, the disclosed subject matter may be embodied as a system, method or computer program product. Accordingly, the disclosed subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, and the like.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method performed by a computerized device, comprising:
obtaining a trace from an hardware accelerator, wherein the trace is generated by the hardware accelerator during simulation of an execution of a test case on a circuit design, wherein the trace includes information regarding instructions which are completed by the circuit design and regarding register value modifications;
identifying a synchronization point in the trace;
simulating, by the computerized device, execution of the test case by a reference model until reaching the synchronization point; and
performing, by the computerized device, instruction-by-instruction checking in order to identify an error in the circuit design based on the simulated execution by the hardware accelerator, wherein the instruction-by-instruction checking is performed with respect to a portion of the trace that relates to operation after executing the synchronization point, wherein the instruction-by-instruction checking utilizes the reference model to determine an expected outcome of each event recorded in the portion of the trace.

2. The computer-implemented method of claim 1, wherein the reference model is a software reference model.

3. The computer-implemented method of claim 1, further comprising:
initially simulating, by the hardware accelerator, execution of the test case on the circuit design until an error is detected;
obtaining a checkpoint representing a state of the circuit design prior to the error;
setting a state of the simulated circuit design using the checkpoint; and
simulating, by the hardware accelerator, execution of a remainder of the test case on the circuit design enhanced by a tracer module, wherein the tracer module is configured to record the trace.

4. The computer-implemented method of claim 1, wherein the synchronization point is an instruction of the test case which appears at an end of an initialization segment of a test within the test case.

5. The computer-implemented method of claim 1, wherein the synchronization point is a semaphore instruction.

6. The computer-implemented method of claim 1, wherein instruction-by-instruction checking is performed with respect to only a portion of the trace, whereby enabling instruction-by-instruction checking with respect to a trace relating to a number of cycles exceeding an efficiency limit of the reference model.

7. A computerized apparatus having a processor, the processor being adapted to perform the steps of:
obtaining a trace from an hardware accelerator, wherein the trace is generated by the hardware accelerator during simulation of an execution of a test case on a circuit design, wherein the trace includes information regarding instructions which are completed by the circuit design and regarding register value modifications;
identifying a synchronization point in the trace;
simulating execution of the test case by a reference model until reaching the synchronization point; and
performing, by the computerized device, instruction-by-instruction checking in order to identify an error in the circuit design based on the simulated execution by the hardware accelerator, wherein the instruction-by-instruction checking is performed with respect to a portion of the trace that relates to operation after executing the synchronization point, wherein the instruction-by-instruction checking utilizes the reference model to determine an expected outcome of each event recorded in the portion of the trace.

8. The computerized apparatus of claim 7, wherein the reference model is a software reference model.

9. The computerized apparatus of claim 7, wherein the processor is further adapted to perform:
initially simulating, by the hardware accelerator, execution of the test case on the circuit design until an error is detected;
obtaining a checkpoint representing a state of the circuit design prior to the error;
setting a state of the simulated circuit design using the checkpoint; and
simulating, by the hardware accelerator, execution of a remainder of the test case on the circuit design enhanced by a tracer module, wherein the tracer module is configured to record the trace.

10. The computerized apparatus of claim 7, wherein the synchronization point is an instruction of the test case which appears at an end of an initialization segment of a test within the test case.

11. The computerized apparatus of claim 7, wherein the synchronization point is a semaphore instruction.

12. The computerized apparatus of claim 7, wherein instruction-by-instruction checking is performed with respect to only a portion of the trace, whereby enabling instruction-by-instruction checking with respect to a trace relating to a number of cycles exceeding an efficiency limit of the reference model.

13. A computer program product comprising a non-transitory computer readable medium retaining program instructions, which instructions when read by a processor, case the processor to performs the steps of:
obtaining a trace from an hardware accelerator, wherein the trace is generated by the hardware accelerator during simulation of an execution of a test case on a circuit design, wherein the trace includes information regarding instructions which are completed by the circuit design and regarding register value modifications;
identifying a synchronization point in the trace;
simulating execution of the test case by a reference model until reaching the synchronization point; and
performing, by the computerized device, instruction-by-instruction checking in order to identify an error in the circuit design based on the simulated execution by the hardware accelerator, wherein the instruction-by-instruction checking is performed with respect to a portion of the trace that relates to operation after executing the synchronization point, wherein the instruction-by-instruction checking utilizes the reference model to determine an expected outcome of each event recorded in the portion of the trace.
